(19) United States
(12) Patent Application Publication
(10) Pub. No.: US 2004/0216953 A1
(43) Pub. Date: Nov. 4, 2004

(54) Tree stand apparatus and method

(76) Inventor: Chico T. Cheeks, Orangeburg, SC (US)

Correspondence Address: RALPH BAILEY, P.A., 125 Broadus Avenue, Greenville, SC, 29601, US

(21) Appl. No.: 10/425,199

(22) Filed: Apr. 30, 2003

(51) Int. Cl. A01M 31/00

(52) U.S. Cl. 182/116

(57) ABSTRACT

A rigid horizontal frame (A) has an access opening (B) permitting a hunter to enter an interior of the frame from a ladder (C) and a step (D) carried beneath the opening upon which the hunter may turn and sit upon a seat (E). An upright safety frame (F) is carried by the rigid frame within which a passageway (G) provides a protected entrance that extends forwardly beyond the rigid frame carrying a forward support (H) for positioning camouflage material out of the way of the hunter entering the stand through the passageway beneath the roof (I).

### BACKGROUND OF THE INVENTION

This invention relates to an accessible tree stand and method wherein a rigid horizontal frame forms a platform for supporting a hunter. An opening in the rigid frame provides access for the hunter to an interior portion of the rigid frame, and a step positioned below the opening forms a stable support on which the hunter may stand and turn while accessing the rigid frame. A support extends forwardly above the opening for suspending camouflage material out of the hunter's way when entering the rigid frame.

Typically, a hunter enters and exits a tree stand with a rifle, shotgun, or bow in hand, while wearing cumbersome boots and hunting garments. The hunter must further enter and exit the tree stand with all necessary supplies such as ammunition, food, cover scent, and firearm or bow repair tools. A hunter typically enters and exits a tree stand when it is dark, either prior to dawn or well after dusk. Thus, the hunter must climb a ladder usually shrouded in camouflage material, carrying a gun or bow plus all necessary supplies, to access a hunting platform usually shrouded in camouflage material, without dropping anything, or falling.

The prior art is exemplified by U.S. Pat. Nos. 4,905,792; 5,242,030; 5,279,390; 5,327,993; 5,394,957; and 5,927,437. Prior tree stands often comprise an elevated hunting platform attached to a ladder the hunter must climb to access the platform. These tree stands require the hunter to use an unprotected ladder to access the platform from the platform's exterior and scramble onto the platform.

### SUMMARY OF THE INVENTION

Accordingly it is an important object of the present invention is to provide convenient access to a tree stand by providing a rigid horizontal frame forming a platform having an access opening through which the hunter enters directly into the interior of the rigid frame.

Another important object of the present invention is to provide a step beneath the opening wherein upon ingress to the rigid frame or egress from the rigid frame, a hunter has a stable support on which to stand and turn.

Another important object of the present invention is to provide a safety frame affixed to the rigid frame for protectively retaining a hunter on the rigid frame.

Yet another important object of the present invention is to provide an extended passageway in the safety frame formed by a forward extension of the safety frame beyond the rigid frame for affording a hunter protected ingress and egress to the rigid frame.

It has been found a tree stand comprising a rigid frame forming a platform which has an opening in the rigid frame, and a step beneath the opening, provides a hunter with improved access to an elevated tree stand. The present invention may further comprise a ladder, securable to the rigid frame and in alignment with the opening, for providing access by the hunter through the opening to an interior portion of the rigid frame. The step may be positioned below the opening in the rigid frame and in alignment with the ladder wherein upon ingress through the opening to the rigid frame, or egress from the rigid frame through the opening the hunter has a stable support on which to stand and turn.

A support for suspending camouflage material therefrom is forwardly spaced in relation to the opening for providing the hunter easy access to the ladder. The tree stand may further comprise a roof and a seat, which is carried by the rigid frame.

Tree stands constructed in accordance with the present invention may include a rigid frame forming a platform provided with a safety frame for concealing and protecting a hunter from the elements. An extended passageway is provided in the safety frame by a forward extension of the safety frame above the rigid frame. The extended passageway affords a hunter protective ingress and egress to the rigid frame. A ladder may be attached to the rigid frame in alignment with the extended passageway and an opening in the frame for providing access by the hunter through the extended passageway and opening to the rigid frame. Further, camouflage material may depend from the extension of the safety frame, thus concealing the rigid frame, the safety frame, the extended passageway and the hunter.

A method of accessing a tree stand in accordance with the claimed invention includes providing an opening in a platform for affording a hunter secure ingress and egress to the interior of the platform, a ladder to the rigid frame in alignment with the opening, positioning a step below the opening in the rigid frame and in alignment with the ladder wherein upon ingress through the opening to the rigid frame, or egress from the rigid frame through the opening, a hunter has a stable support on which to stand and turn, thereby accessing the rigid frame to assume a hunting position.

A method of constructing a tree stand in accordance with the claimed invention includes the steps of forming a rigid frame positionable above the ground and capable of supporting a hunter, upon a seat on the rigid frame, securing a safety frame to the rigid frame for protectively retaining a hunter on the rigid frame, extending the safety frame forwardly of the rigid frame and opening forming an extended passageway for affording a hunter protective ingress and egress to the rigid frame, securing a ladder to the rigid frame in alignment with the extended passageway and opening for providing access by the hunter through the extended passageway and the opening to the rigid frame, and positioning camouflage material for concealing the rigid frame, the safety frame, the extended passageway, and the hunter. While the opening is preferably a frontal opening in the frame, a conveniently accessible opening in another location on the frame may suffice.

### BRIEF DESCRIPTION OF THE DRAWINGS

The construction designed to carry out the invention will be hereinafter described, together with other features thereof.

The invention will be more readily understood from a reading of the following specification and by reference to the accompanying drawings forming a part thereof, wherein an example of the invention is shown and wherein:

FIG. 1 is a left front perspective view illustrating a tree stand constructed in accordance with the present invention including a horizontal rigid frame for supporting a hunter having an access opening in the frame for accessing the interior of the horizontal frame and having an attached safety frame and roof together with camouflage material depending from a forward extension of the safety frame over a ladder preferably carried in alignment with the access opening;

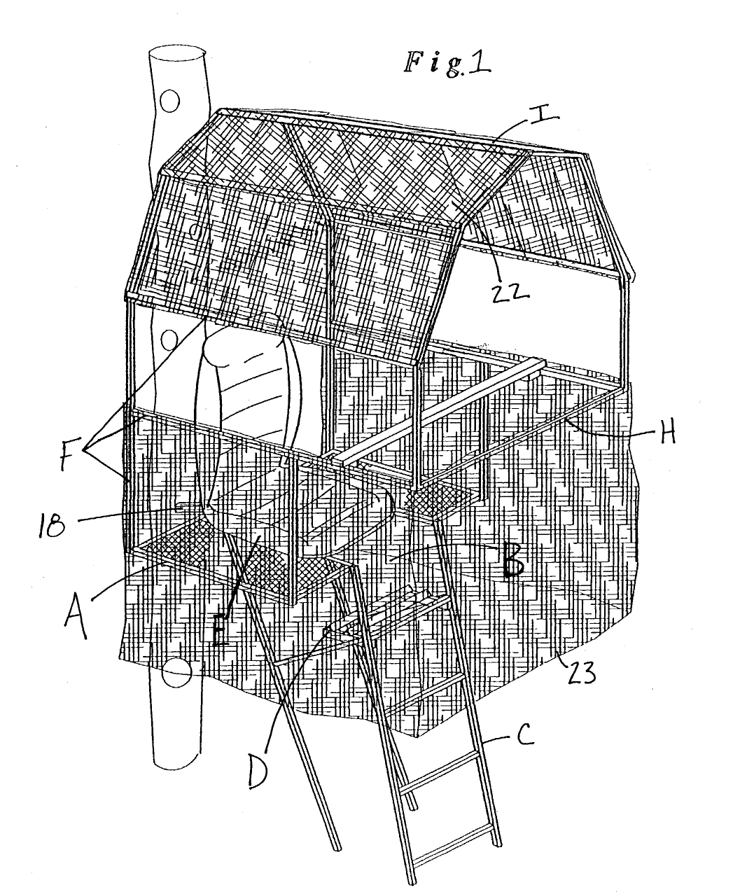

FIG. 2 is a left front perspective view similar to FIG. 1 with camouflage and roof covering omitted illustrating the safety frame and roof secured to the horizontal rigid frame with an access opening in the frame and having a step therebeneath to permit a hunter to stand or turn prior to seating in an interior portion of the frame, further illustrating a passageway formed by forward extension of the safety frame and the roof providing access to the interior of the horizontal frame;

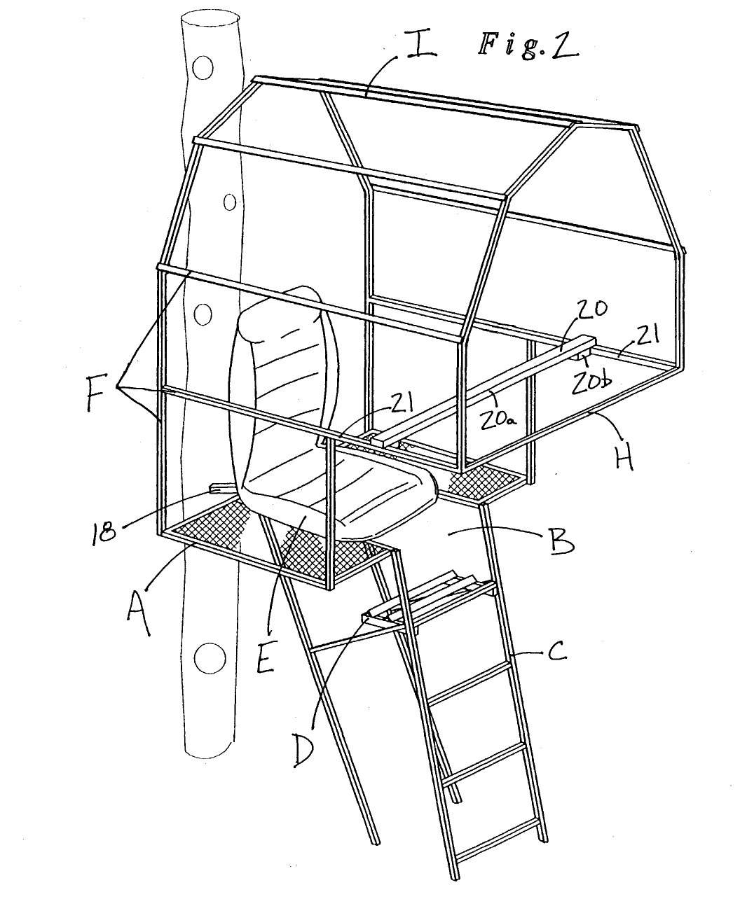

FIG. 3 is a perspective view at an enlarged scale illustrating an interior of the horizontal frame including the access opening therein extending from the passageway with the step therehenwith permitting a hunter to stand on the step within the passageway after gaining access to the stand without undue interference from depending camouflage permitting a class access to the horizontal frame; and

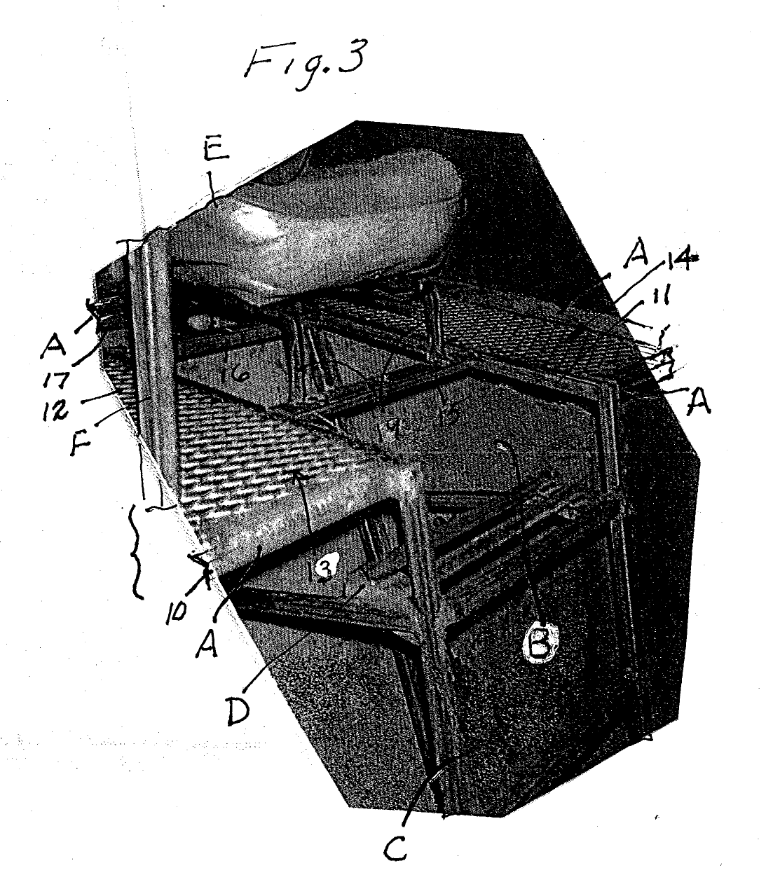

FIG. 4 is a left side elevational view illustrating the tree stand constructed in accordance with the present invention with an attached seat, safety frame and roof.

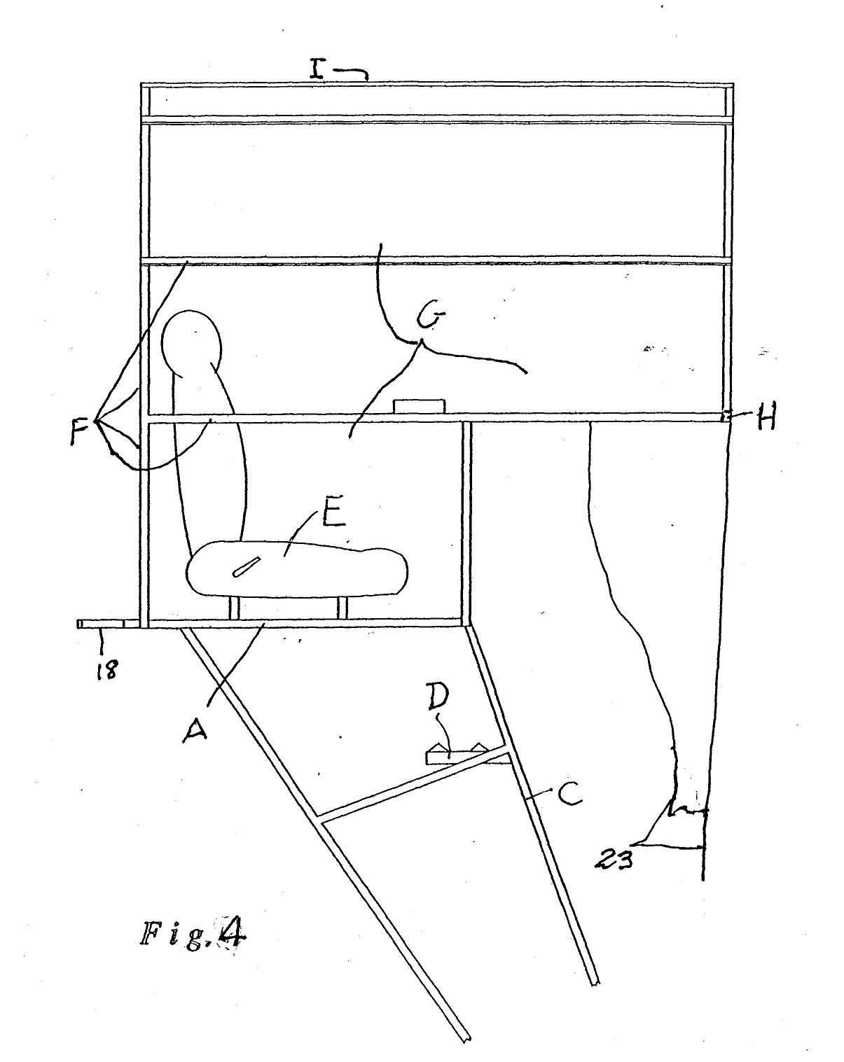

### DESCRIPTION OF A PREFERRED EMBODIMENT

The drawings illustrate an apparatus and method for accessing a tree stand wherein a rigid horizontal frame A is provided forming a platform for supporting a hunter. The rigid frame has an access opening B affording an entryway for the hunter to an interior portion of the rigid frame. A ladder C is carried in fixed relation to the horizontal frame to facilitate access to the tree stand by the hunter. The ladder is preferably positioned in alignment with the access opening in the rigid frame for providing direct access by the hunter to an interior portion of the rigid frame. A step D is carried by the rigid frame below the opening and is accessible from the ladder. The step forms a stable support on which the hunter may stand and turn. A seat E may be carried by the rigid frame and is preferably fixed for use by the hunter.

A vertical safety frame F is affixed to the rigid frame for protecting the hunter on the rigid frame. A passageway G is provided in the safety frame extending forwardly beyond the rigid frame for affording a hunter protective ingress and egress to the rigid frame. A forward extension of the frame includes a support H for carrying camouflage material depending therefrom forming a font of the passageway for concealing the hunter. Encompassing the rigid frame, passageway and seat is a roof I that conceals the hunter from game animals and protects the hunter from the elements. The support H is provided for positioning camouflage material in a forwardly spaced relation to the opening to keep the camouflage material out of the hunter's way, and provide the hunter easy access to and from the ladder. Thus, improved access to an elevated tree stand is provided by allowing the hunter to stand atop the step within the opening and turn to sit upon the seat.

The rigid horizontal frame A comprises suitable structural members such as angles 10 and hollow rectangular metal tubing 11, for carrying expanded metal flooring material 12 to form a platform capable of supporting a hunter. The frame is preferably rectangular having a pair of spaced elongated rectangular floor panel broadly designated at 13 and 14. The floor panels are bridged by transverse supports 15 and 16 and a frame member 17 extends across the rear of the platform formed by the frame A. An entrance opening B is thus provided at the front of the frame between the floor panels.

A ladder C is preferably aligned with the opening B and the step D although alignment is not required. The access opening B is preferably positioned in a front intermediate portion of the rigid frame A. The drawings illustrate a rectangular frontal opening B. In use, a hunter climbs ladder C to reach step D, upon which the hunter may stand or turn within the opening to access an interior portion of rigid frame A.

Apparatus for attaching the stand to a tree may include a V-shaped fastener member 18 carried by the rigid frame A to secure the tree stand to the trunk of a tree. The tree fastener apparatus may include a variety of ancillary devices such as belts, bungee cords, chains, clamps, and fasteners such as nails, nuts, bolts, screws, and threaded rod (not shown). The tree fastener apparatus may be constructed from other materials configured to secure the elevated tree stand to the trunk of a tree, having the strength to support the load of the occupied and unoccupied tree stand, and may have other configurations allowing the tree stand to be permanently or removably securable to the trunk of a tree.

A seat E is preferably carried on suitable support legs 19 between the expanded metal flooring panel 13 and 14. The seat E is preferably carried on the rigid frame opposite the access opening B and in alignment with the ladder C and step D. The seat E may comprise automobile seats, boat seats, camping seats, folding seats, swivel seats, collapsible and adjustable height seats, fixed seats and stools of the type constructed with a seat bottom 26a and a seatback 26b joined to comfortably cradle the hunter in a seated hunting position. The seat is preferably configured to allow the hunter to adjust the seat backwards on forward leg and in relation to the rigid frame, and may further be configured to allow the hunter to adjust the entire seat position in relation to the rigid frame. In a preferred operation, a hunter climbs the ladder to reach the step, upon which a hunter may stand or turn within the opening to access the seat carried by the rigid frame to assume a seated hunting position. The seat E may comprise other types of seats and stool designs that are removable and having the strength to support a seated hunter when carried upon the rigid frame.

The rigid frame A further carries a safety frame F and cover I. The safety frame is carried by the rigid A frame for protectively retaining a hunter on the rigid frame and preferably comprises hollow rectangular metal tubing configured to encapsulate the rigid frame and form an extended passageway G. The extended passageway G is formed by a forward extension of the safety frame beyond the rigid frame. The extended passageway affords a hunter protective ingress and egress to the rigid frame by providing a forwardly extending opening in the safety frame through which a hunter may access opening B and the rigid frame without fear of falling from ladder C or the rigid frame. The safety frame may further include a shooting rest 20 that is removably securable to the safety frame to provide a hunter a sturdy platform to steady and aim a firearm or bow prior to discharge. The gun rest 20 is illustrated as including an elongated transverse member 20a and stops 20b adjacent each end for positioning the gun rest for sliding adjustment between the rails 21 of the safety frame.

A roof I is carried by the safety frame forms an upper part of passageway G for concealing and protecting a hunter from the elements and preferably comprises hollow rectangular metal tubing configured to complement the configuration of safety frame. The roof is preferably covered with a heavy tarpaulin 22. Camouflage material 23 may be configured to depend from the forward support H to conceal, and protect the rigid frame A from the elements. The camouflage material 23 preferably comprises fabric having suitable designs thereon to merge with the surrounding background. The camouflage material 23 may be constructed from other materials such as burlap, wood, vinyl, tarpaulin, plastic, and aluminum, and may have other camouflage or solid color configurations which allow the tree stand to blend with the surrounding background.

The rigid frame A is secured to ladder C in alignment with opening B, although this alignment is not required. The ladder preferably comprises hollow rectangular metal tubing configured to form two parallel sidepieces connected by a series of rungs upon which a hunter steps in climbing up or down. The ladder C is preferably configured with two ends, the first end contacting the ground, and the second end affixed to the rigid frame A. In a preferred operation a hunter climbs the ladder to reach step D, upon which the hunter may stand or turn within opening B to access an interior portion of rigid frame A.

In an alternative embodiment, the ladder C may be detachably securable to rigid frame A, wherein the ladder may be detached and removed from the rigid frame to prevent unauthorized access to tree stand it is not in use. The ladder C may be constructed from other materials having the strength to support a climbing hunter, and may have other configurations allowing a hunter to reach step D upon which the hunter may stand or turn within opening B to access an interior portion of rigid frame A.

The step D is preferably constructed of hollow rectangular metal tubing configured to form a stable support upon which a hunter may stand or turn. The step is preferably positioned below opening B in rigid frame A and in alignment with ladder C, although this alignment is not required. In a preferred operation, a hunter climbs the ladder to reach the step upon which the hunter may stand or turn within the opening to access an interior portion of the rigid frame. The step may be further configured to function as a foot rest for a hunter seated in seat E when carried upon the rigid frame. The step D may be constructed from other materials having the strength to support the load of a hunter, and may have other configurations affording the hunter a stable support upon which to stand and turn within opening B to access an interior portion of rigid frame A.

The support H is spaced forwardly of opening B, and supports depending camouflage material 23 for concealing tree stand and the hunter. The support positions depending camouflage material forwardly of the opening out of the hunter's way, thus providing the hunter easy access to and from ladder C. The camouflage material may further be configured to depend from rigid frame A, safety frame and roof. The camouflage material preferably comprises fabric designed merge with the surrounding background.

While a preferred embodiment of the invention has been described using specific terms, such as description is for illustrative purposes only, and it is to be understood that changes and variations may be made without departing from the spirit or scope of the following claims.

What is claimed is:

1. A tree stand, comprising:
a rigid frame forming a platform for supporting a hunter;
an access opening forming an entryway in the frame for a hunter to gain access to an interior portion of the frame;
a ladder attachable to the frame in alignment with the opening for providing access by the hunter to the opening;
a step positioned below the opening in the rigid frame and in alignment with the ladder wherein upon ingress through the opening to the frame, or egress from the rigid frame through the opening the hunter has a stable support on which to stand or turn; and
a support extending forwardly of the opening for suspending camouflage material concealing the rigid frame, the opening, and the hunter from game animals.

2. The tree stand as set forth in claim 1, including a fastener for securing the tree stand to the trunk of a tree.

3. The tree stand as set forth in claim 1, including a seat carried by the platform.

4. The tree stand as set forth in claim 1, wherein the rigid frame is rectangular providing a rectangular frontal opening in the frame.

5. A tree stand comprising:
a rigid frame forming a platform for supporting a hunter;
a frontal opening in the rigid frame for providing access to an interior portion of the rigid frame by the hunter;
a ladder attachable to the frame in alignment with the opening for providing access by the hunter through the opening; and
a step positioned below the opening in the rigid frame and in alignment with the ladder wherein upon ingress through the opening to the rigid frame or egress from the rigid frame through the opening a hunter has a stable support on which to stand or turn.

6. The tree stand as set forth in claim 5, wherein the tree stand further comprises a support spaced forwardly of the opening for supporting depending camouflage material for concealing the rigid frame, the opening, the seat, and the hunter.

7. The tree stand as set forth in claim 5, wherein the seat is fixed in relation to the rigid frame.

8. A tree stand comprising:
a rigid horizontal frame forming a platform for supporting a hunter;
a vertical safety frame affixed to the rigid frame for protectively retaining a hunter on the rigid frame;
a passageway in the safety frame extending forwardly beyond the rigid frame for affording a hunter protective ingress and egress to the rigid frame;
a ladder for providing access by the hunter through the passageway to the rigid frame; and
a forward extension of the vertical frame including a support for carrying camouflage material depending therefrom forming a front of the passageway for concealing the hunter.

9. The tree stand set forth in claim 8, including an entry opening in the rigid frame providing easy access from the passageway to an interior portion of the rigid frame by the hunter;

10. The tree stand as set forth in claim 8 including a shooting rest removably securable to the safety frame wherein a hunter may steady a gun prior to discharge.

11. The tree stand as set forth in claim 8, including a roof affixed to the safety frame enclosing safety frame and the rigid frame, thereby providing a hunter concealment and protection from the elements.

12. The tree stand as set forth in claim 8, wherein the passageway extends outward to overhang the ladder, wherein the hunter directly enters the passageway and opening to access the rigid frame and directly exits the frame through the opening and passageway to access the ladder.

13. A tree stand, comprising
a rigid frame forming a platform for supporting a hunter;
an opening in the rigid frame for affording a hunter secure ingress and egress to the frame;
a seat carried by the rigid frame;
a safety frame affixed to the rigid frame for protectively retaining a hunter on the rigid frame;
a passageway in the safety frame formed by a forward extension of the safety frame extending beyond the rigid frame for affording a hunter protective ingress and egress to the frame;
a ladder attached to the rigid frame in alignment with the extended passageway and opening for providing access by the hunter through the passageway and opening to the rigid frame;
a step positioned below the opening in alignment with the ladder wherein upon ingress through the opening to the rigid frame or egress from the frame through the opening a hunter has a stable support on which to stand and turn; and
a support spaced forwardly of the opening supporting depending camouflage material depending from the extended passageway for concealing the rigid frame, the opening, the safety frame, the extended passageway, and the hunter from game animals.

14. A method of hunting from a tree stand, comprising the steps of:
forming a rigid frame defining a platform above the ground and capable of supporting a hunter;
providing a opening in the rigid frame for affording a hunter secure ingress and egress to the rigid frame;
securing a ladder to the rigid frame for providing access to the opening in the rigid frame; and
positioning a step below the opening in the rigid frame wherein upon ingress through the opening to the rigid frame, or egress from the rigid frame through the opening, a hunter has a stable support on which to stand and turn, thereby accessing the frame to assume a hunting position.

15. A method of constructing a tree stand, comprising the steps of:
forming a rigid frame defining a platform positionable above the ground and capable of supporting a hunter;
forming an opening in the rigid frame for affording a hunter secure ingress and egress to the rigid frame;
positioning a seat on the rigid frame;
securing a safety frame to the rigid frame for protectively retaining a hunter on the rigid frame;
extending the safety frame forwardly of the rigid frame and the opening forming an extended passageway for affording a hunter protective ingress and egress to the hunting frame;
affixing a ladder to the frame in alignment with the extended passageway and opening for providing access by the hunter through the extended passageway and the opening to the rigid frame; and
positioning camouflage material for concealing the rigid frame, the safety frame, the extended passageway and the hunter from game animals.

16. The method of construction as set forth in claim 15, further comprising the step of providing a rectangular frontal opening in the rigid frame for affording a hunter secure ingress and egress to the rigid frame;

17. The method of construction set forth in claim 15, further comprising the step of providing a rigid frame comprising a rectangular perimeter.

18. A tree stand, comprising:
a rigid frame forming a platform for supporting a hunter;
an opening in the rigid frame for providing access to the rigid frame by the hunter; and
a ladder in alignment with the opening for providing access for a hunter to the rigid frame.

19. The tree stand as set forth in claim 18, wherein the ladder is fixed to the rigid frame.
